(19) United States
(12) Patent Application Publication
(10) Pub. No.: US 2024/0346741 A1
(43) Pub. Date: Oct. 17, 2024

(54) METHOD AND SYSTEM OF PROCESSING GRAPHICS DATA WITH TILE-BASED RENDERING PIPELINE

(71) Applicant: Mediatek Inc., Hsinchu (TW)

(72) Inventors: Chengping Luo, San Jose, CA (US); You-Ming Tsao, Hsinchu (TW); Bozhan Chen, San Jose, CA (US); Sheng-Wen Huang, San Jose, CA (US)

(21) Appl. No.: 18/626,411

(22) Filed: Apr. 4, 2024

Related U.S. Application Data
(60) Provisional application No. 63/495,802, filed on Apr. 13, 2023.

(51) Int. Cl. G06T 15/00

(52) U.S. Cl. CPC G06T 15/005; G06T 2210/12

(57) ABSTRACT

In aspects of the disclosure, a method, a system, and a computer-readable medium, are provided. The method for processing graphics data with a graphics rendering pipeline comprising a mesh shader and a tiler, comprising outputting, by the mesh shader in response to an input of the graphics data, legacy mesh shader output parameters including vertices and primitives, and additional data with a meshlet bounding-box, or axis-aligned bounding box (AABB) structure; sending the AABB to the tiler as an input, and generating, by the tiler, a visibility stream according to the AABB, wherein each entity of the visibility stream indicates that the AABB is fully visible, partially visible, or invisible in the view frustum; and sending the visibility stream back to the tiler as a further input along with the legacy mesh shader output parameters for coming rasterization in a fragment pass.

### CROSS-REFERENCE TO RELATED APPLICATION(S)

This application claims the benefits of U.S. Provisional Application Ser. No. 63/495,802, entitled “VK_KHR_mesh_shader” and filed on Apr. 13, 2023, which is expressly incorporated by reference herein in its entirety.

### BACKGROUND

### Field

The present disclosure relates generally to graphics data processing, and more particularly, to methods and systems of processing graphics data with tile-based rendering pipeline.

### Background

The statements in this section merely provide background information related to the present disclosure and may not constitute prior art.

In graphics data processing pipelines, mesh shaders are designed to increase or reduce the amount of primitive by relaxing the constraints of traditional rendering pipeline. Benefits include removing serialized, unscalable fixed-function bottlenecks, optimizing vertex reuse/reducing attribute fetch, working “in-pipe” and “compute-like” programmable pipeline.

Mesh shaders enable sorts of culling algorithms ahead of the hardware rasterizer and prevent from shading invisible primitives and vertices with an immediate-mode rendering (IMR) GPU silicon. The application can specify an optional AS (or TS) stage, and a mandatory MS (Mesh Shader) stage in pipeline. MS outputs comprise vertices and primitives associating of a threadgroup thread. The number of output vertices and primitives must be specified at runtime by the shader. Inputs to the MS do not have IA enabled. Input payload of MS matches what dispatched from AS.

However, mesh shaders are not fitting well with current tile-based rendering (TBR) GPU silicon equipped with a fixed-function Tiler unit inside because, mesh shaders usually output huge amount of data at runtime that the driver cannot allocate upfront for starting a Tiler job, and allocating or deallocating memory by GPU means there will be a GPU memory management unit (MMU) or some memory management mechanism on GPU side which will induce extra hardware or firmware cost to support more complex memory layouts and policies.

Therefore, a heretofore unaddressed need exists in the art to address the deficiencies and inadequacies.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

In aspects of the disclosure, a method, a system, and a computer-readable medium are provided.

In one aspect, the disclosure relates to a method for processing graphics data with a graphics rendering pipeline comprising a mesh shader and a tiler.

The method comprises outputting, by the mesh shader in response to an input of the graphics data, legacy mesh shader output parameters including vertices and primitives, and additional data with a meshlet bounding-box, or axis-aligned bounding box (AABB) structure; sending the AABB to the tiler as an input, and generating, by the tiler, a visibility stream according to the AABB, wherein each entity of the visibility stream indicates that the AABB is fully visible, partially visible, or invisible in the view frustum; and sending the visibility stream back to the tiler as a further input along with the legacy mesh shader output parameters for coming rasterization in a fragment pass.

In one embodiment, the tiler comprises a visibility test configured to determine if the AABB is visible in the current view frustum.

In one embodiment, the visibility test is implemented by hardware and/or software.

In one embodiment, the invisible AABB, which has no corresponding entity or is indicated as invisible found with its corresponding entity of the visibility stream, is regarded culled and not be rendered with its bounded vertices and primitives.

In one embodiment, only the vertices and primitives bounded by the AABB which is indicated visible in the visibility stream are rendered in the fragment pass.

In one embodiment, the AABB is the smallest possible rectangle or polygon aligned with the axes of that element's user coordinate system that entirely encloses it and its descendants.

In one embodiment, the visibility stream is a bit stream or an index buffer with the smallest possible storage size, and wherein the value of each entity in the visibility stream is identified as any degree of visibility of the corresponding AABB in the view frustum, or a direct or an indirect address to access any data of the fully or partially visible AABB.

In one embodiment, the visibility stream is a compressed data, and the decompression of it is involved in the fragment pass.

In one embodiment, the visibility stream may be operated as an additional input in the fragment pass, or be used as a factor for judging the eligibility of the mesh shader being executed in the fragment pass and rendered in the later fragment shader stage, or being skipped in the fragment pass.

In another aspect, the disclosure relates to a system for processing graphics data, comprising a compiler; and a graphics rendering pipeline comprising a mesh shader and a tiler, coupled with the compiler, and configured such that: in response to an input of the graphics data, the mesh shader outputs legacy mesh shader output parameters including vertices and primitives, and additional data with a meshlet bounding-box, or axis-aligned bounding box (AABB) structure; in a first pass, the compiler instructs the AABB being sent to the tiler as an input, and the tiler then generates a visibility stream accordingly, wherein each entity of the visibility stream indicates that the AABB is fully visible, partially visible, or invisible in the view frustum; and in a consecutively second pass, the compiler instructs the visibility stream being sent back to the tiler as a further input along with the legacy mesh shader output parameters for coming rasterization in a fragment pass.

In one embodiment, the tiler comprises a visibility test configured to determine if the AABB is visible in the current view frustum.

In one embodiment, the visibility test is implemented by hardware and/or software.

In one embodiment, the invisible AABB, which has no corresponding entity or is indicated as invisible found with its corresponding entity of the visibility stream, is regarded culled and not be rendered with its bounded vertices and primitives.

In one embodiment, only the vertices and primitives bounded by the AABB which is indicated visible in the visibility stream are rendered in the fragment pass.

In one embodiment, the AABB is the smallest possible rectangle or polygon aligned with the axes of that element's user coordinate system that entirely encloses it and its descendants.

In one embodiment, the visibility stream is a bit stream or an index buffer with the smallest possible storage size, and wherein the value of each entity in the visibility stream is identified as any degree of visibility of the corresponding AABB in the view frustum, or a direct or an indirect address to access any data of the fully or partially visible AABB.

In one embodiment, the visibility stream is a compressed data, and the decompression of it is involved in the fragment pass.

In one embodiment, the visibility stream may be operated as an additional input in the fragment pass, or be used as a factor for judging the eligibility of the mesh shader being executed in the fragment pass and rendered in the later fragment shader stage, or being skipped in the fragment pass.

In yet another aspect, the disclosure relates to a non-transitory computer readable storage medium storing instructions, which when executed by one or more processors, cause the above disclosed method of processing graphics data to be performed.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 shows an exemplary configuration of a graphics tile-based rendering pipeline, according to some embodiments.

FIG. 2 shows a mesh shader function header with a new built-it output argument, OutputAABB structure, in the shader language, according to some embodiments.

FIG. 3 shows a flowchart for the method of processing graphics data with a graphics rendering pipeline, according to some embodiments.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunications systems will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example aspects, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

VK_EXT_mesh_shader introduces a huge GPU (Graphics Processing Unit) memory bandwidth during the processing of task and mesh shaders, however, there are still tiling GPU implementations suffering from not being able to support it with even far away from the efficiency as one can expect comparing to GPU architectures with no tiler.

There are tons of pain points preventing tiling GPUs to support the current VK_EXT_mesh_shader model. For example:
The pre-pass of a vertex shader, which is designed to suppress the amount of geometry and vertex data before rendering, works well on splitting position and varying data however does not work efficiently with the task and mesh shaders.
The size of output data from the task and mesh shaders is dynamic and could be emitted extremely large. It becomes the device memory and bandwidth bottlenecks especially for budgeted devices equipped with the tiling GPUs and usually the limited memory.

There are some proposals aiming to find a way to make the flexible geometry pipeline being widely adopted and compatible by not only the GPU implementations without tiler but also the tiling GPUs.

One of the proposals is to include an additional MMU or free memory chunk list on GPU side to manage the allocation of deallocation of explosive amount of mesh shader output data. However, the design needs extra hardware cost and more complex firmware design of memory layouts and policies for efficient memory usage dynamically.

Another proposal is to limit the amount or size of vertices and primitives for task and mesh shader outputs.

By limiting the maximum size of task and mesh shader outputs, tiling GPUs may have the opportunity to store all the subgroups in their own GPU memory. However, it will oppositely suppress the scalability and flexibility of mesh shaders used with some non-tiling GPUs who advertise their higher maximum that developers can freely emit more than the limitation defined in the specification. Besides the optimal output sizing depends highly on the GPU implementations. Different GPUs will have different optimal output sizing.

The other proposal is to introduce a new resource like meshlet, or a new resource type or compound structure.

To let the GPU driver know the size to be allocated precisely by using a new resource type, or compound structure, which effectively encapsulates all the static meshlets of a drawcall, is somehow a doable way for tiling GPU implementations to leverage the existing fixed-function input assembler and vertex shading passes. However, it brings a new different solution which is incompatible with the existing mesh shader, developers will suffer from extra overhead managing their geometry assets in a different way from those have been developed for the existing vertex shaders and mesh shaders. Clearly, it is not a good choice for portability.

One aspect of this disclosure is to provide a graphics tile-based rendering pipeline in which mesh shader(s) are configured to output, in addition to legacy mesh shader output parameters including vertices and primitives, a new parameter with a bounding-box or axis-aligned bounding box (AABB) structure (hereinafter, the “AABB”).

The graphics tile-based rendering pipeline is configured to reuse the existing task and mesh shaders with an additional AABB output, enabling tiling GPUs to be more easily implemented with their early primitive culling pass by saving extra memory bandwidth before rendering, while it preserves the flexibility of using existing task shaders to do their own culling relied on the intension of developers' favor with non-tiling GPUs. With few changes in the mesh shaders, the geometry generation procedure and assets management working smoothly with the existing pipeline can be preserved mostly and reused with a runtime calculated bounding box, given that developers will be easily porting their existing task and mesh shader algorithms onto devices with tiling GPUs.

To implement the novel graphics tile-based rendering pipeline according to the invention, the following new properties are added to the application programming interface (API) which is cloned from VkPhysicalDeviceMeshShaderPropertiesEXT—some dictating hard limits, and others indicating performance considerations:

| typedef struct VkPhysicalDeviceMeshShaderPropertiesKHR { | | |
|---|---|---|
| { | | |
| // | ... | cloned from struct |
| VkPhysicalDeviceMeshShaderPropertiesEXT | | |
| uint32_t | | maxMeshOutputAABB; |
| uint32_t | | meshOutputPerAABBGranularity; |
| VkBoo132 | | prefersLocalInvocationAABBOutput; |
| VkBoo132 | | prefersCompactAABBOutput; |
| // | ... | cloned from struct |

VkPhysicalDeviceMeshShaderPropertiesEXT
} VkPhysicalDeviceMeshShaderPropertiesEXT;

The following limits affect task shader execution:
maxMeshOutputAABB is the maximum number of bounding boxes a mesh shader can emit.

When considering the above properties, the number of mesh shader outputs that a shader uses are rounded up to implementation-defined numbers defined by the following properties:
meshOutputPerPrimitiveGranularity is the alignment of each per-AABB mesh shader output.

According to the invention, the following properties are implementation preferences. Violating these limits will not result in validation errors, but it is strongly recommended that applications adhere to them in order to maximize performance on each implementation.
If prefersLocalInvocationAABBOutput is VK_TRUE, the implementation will perform best when each invocation writes to an array index in the per-AABB output matching code: LocalInvocationIndex.
If prefers Compact AABBOutput is VK_TRUE, the implementation will perform best if there are no unused AABB in the output array.

Note that even if some of the above values are false, the implementation can still perform just as well whether or not the corresponding preferences are followed. It is recommended to follow these preferences unless the performance cost of doing so outweighs the gains of hitting the optimal paths in the implementation.

Besides cloning from VkPhysicalDeviceMeshShaderFeaturesEXT, a new feature is introduced by this extension:

```
typedef struct VkPhysicalDeviceMeshShaderFeaturesKHR {
  // ... cloned from struct
VkPhysicalDeviceMeshShaderFeaturesEXT
  VkBoo132 primitiveFragmentShadingRateMeshShader;
  VkBoo132 meshShaderOutputAABB;
  // ... cloned from struct
VkPhysicalDeviceMeshShaderFeaturesEXT
} VkPhysicalDeviceMeshShaderFeaturesEXT;
```

meshShaderOutputAABB indicates support for the bounding box pass especially for tiling GPUs.

In addition, GLSL Changes include: each layout qualifier is declared as layout (<qualifier>) out.

A new auxiliary storage qualifier, beside of perprimitiveEXT, can be added to interface variables to indicate that it is per-AABB rate:
peraabbKHR

New write-only output blocks are defined for built-in output values from mesh shaders:

```
peraabbKHR out gl_MeshPerAABBEXT {
  vec3 topLeftNear;
  vec3 bottomRightFar;
} gl_MeshAABBEXT [ ];
```

Without intent to limit the scope of the invention, some exemplary embodiments of the invention are given below.

In some embodiments, the method for processing graphics data with a graphics rendering pipeline comprising a mesh shader and a tiler, comprising outputting, by the mesh shader in response to an input of the graphics data, legacy mesh shader output parameters including vertices and primitives, and additional data with a AABB structure; sending the AABB to the tiler as an input, and generating, by the tiler, a visibility stream according to the AABB, wherein each entity of the visibility stream indicates that the AABB is fully visible, partially visible, or invisible in the view frustum; and sending the visibility stream back to the tiler as a further input along with the legacy mesh shader output parameters for coming rasterization in a fragment pass.

In some embodiments, the tiler comprises a visibility test configured to determine if the AABB is visible in the current view frustum.

In some embodiments, the visibility test is implemented by hardware and/or software.

In some embodiments, the invisible AABB, which has no corresponding entity or is indicated as invisible found with its corresponding entity of the visibility stream, is regarded culled and not be rendered with its bounded vertices and primitives.

In some embodiments, only the vertices and primitives bounded by the AABB which is indicated visible in the visibility stream are rendered in the fragment pass.

In some embodiments, the AABB is the smallest possible rectangle or polygon aligned with the axes of that element's user coordinate system that entirely encloses it and its descendants.

In some embodiments, the visibility stream is a bit stream or an index buffer with the smallest possible storage size, and wherein the value of each entity in the visibility stream is identified as any degree of visibility of the corresponding AABB in the view frustum, or a direct or an indirect address to access any data of the fully or partially visible AABB.

In some embodiments, the visibility stream is a compressed data, and the decompression of it is involved in the fragment pass.

In some embodiments, the visibility stream may be operated as an additional input in the fragment pass, or be used as a factor for judging the eligibility of the mesh shader being executed in the fragment pass and rendered in the later fragment shader stage, or being skipped in the fragment pass.

It should be noted that all or a part of the steps of the method according to the embodiments of the invention is implemented by hardware or software module(s) executed by one or more processors, or implemented by a combination thereof.

In another embodiments, the invention provides a system for processing graphics data, comprises a compiler; and a graphics rendering pipeline comprising a mesh shader and a tiler, coupled with the compiler, and configured such that: in response to an input of the graphics data, the mesh shader outputs legacy mesh shader output parameters including vertices and primitives, and additional data with a AABB structure; in a first pass, the compiler instructs the AABB being sent to the tiler as an input, and the tiler then generates a visibility stream accordingly, wherein each entity of the visibility stream indicates that the AABB is fully visible, partially visible, or invisible in the view frustum; and in a consecutively second pass, the compiler instructs the visibility stream being sent back to the tiler as a further input along with the legacy mesh shader output parameters for coming rasterization in a fragment pass.

In some embodiments, the tiler comprises a visibility test configured to determine if the AABB is visible in the current view frustum.

In some examples, the visibility test is implemented by hardware and/or software.

In some examples, the invisible AABB, which has no corresponding entity or is indicated as invisible found with its corresponding entity of the visibility stream, is regarded culled and not be rendered with its bounded vertices and primitives.

In some examples, only the vertices and primitives bounded by the AABB which is indicated visible in the visibility stream are rendered in the fragment pass.

In some examples, the AABB is the smallest possible rectangle or polygon aligned with the axes of that element's user coordinate system that entirely encloses it and its descendants.

In some examples, the visibility stream is a bit stream or an index buffer with the smallest possible storage size, and wherein the value of each entity in the visibility stream is identified as any degree of visibility of the corresponding AABB in the view frustum, or a direct or an indirect address to access any data of the fully or partially visible AABB.

In some examples, the visibility stream is a compressed data, and the decompression of it is involved in the fragment pass.

In some examples, the visibility stream may be operated as an additional input in the fragment pass, or be used as a factor for judging the eligibility of the mesh shader being executed in the fragment pass and rendered in the later fragment shader stage, or being skipped in the fragment pass.

In the following description, numerous specific details are set forth regarding the systems and methods of the disclosed subject matter and the environment in which such systems and methods may operate, etc., in order to provide a thorough understanding of the disclosed subject matter. In addition, it will be understood that the examples provided below are exemplary, and that it is contemplated that there are other systems and methods that are within the scope of the disclosed subject matter.

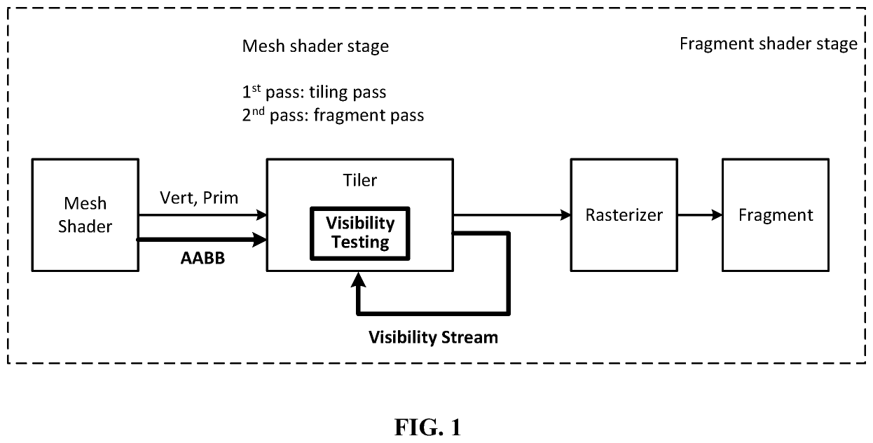

FIG. 1 shows an exemplary configuration of a graphics tile-based rendering pipeline, according to some embodiments. According to the invention, a new parameter “AABB” is created as an output from the mesh shader.

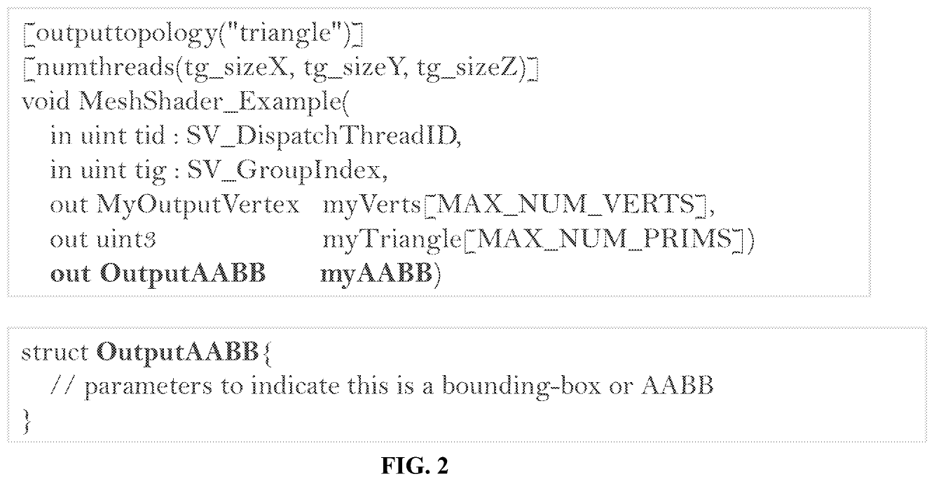

According to some embodiments, in the shader language, a new built-it output argument, OutputAABB structure, is added to the existing mesh shader function header as shown in FIG. 2.

In some examples, the bounding-box or AABB is the smallest possible rectangle or polygon (aligned with the axes of that element's user coordinate system) that entirely encloses it and its descendants.

In some examples, the visibility stream is a bit stream or an index buffer with the smallest possible storage size. The value of each entity in the visibility stream is identified as, but not limited to, any degree of visibility of the corresponding AABB in the view frustum, or a direct or an indirect address to access any data of the fully or partially visible AABB.

In some examples, the visibility stream can be a compressed data, and the decompression will be involved in the fragment pass.

Given the fact that the tiler is capable of culling invisible primitives that only the visible primitives not been culled will be rendered all the way down to the fragment pass. We reduce amount of memory usage and primitives to be rendered from the mesh shader output by extending the concept of culling which boost the whole pipeline with the mesh shaders for the tile-based rendering (TBR) GPU silicon.

According to the invention, in the data-flow with the TBR GPUs, the compiler may split the mesh shader into two consecutive passes—a tiling pass (first pass) and a fragment pass (second pass).

In some examples, the tilingpass uses the single AABB output from the mesh shader. The AABB output is operated in a functional block “Visibility Test” in the tiler. The “Visibility Test” can be implemented by the hardware or software. The tiler then output (an) internal or external “Visibility Stream(s)”, as shown in FIG. 1. In the tiling-pass, the compiler operably instructs the AABB data being regarded as an input to the tiler and being tested such as box-culling further to see if it is visible in current view frustum.

In some embodiments, after the visibility test in the tiling pass, the tiler then outputs the visibility stream as a further input parameter along with the legacy mesh shader output parameters (vertices, primitives) to the tiler again for coming rasterization in the fragment pass. Those may be instructed by the consecutive fragment pass of the compiler.

In some examples, the visibility stream(s) may be operated as an additional input in the fragment pass, or be used as a factor for judging the eligibility of the mesh shader being executed in the fragment pass and rendered in the later fragment shader stage, or being skipped in the fragment pass.

In some embodiments, only the vertices and primitives bounded by the AABB which was indicated visible in the visibility stream are rendered in the fragment pass.

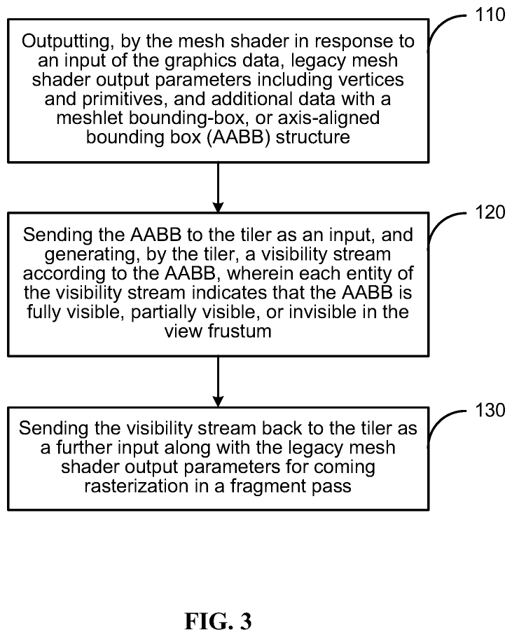

Referring to FIG. 3, a flowchart for the method o method for processing graphics data with a graphics rendering pipeline comprising a mesh shader and a tiler coupled with a compiler is shown according to some embodiments of the invention.

According to the method, at step 110, the mesh shader, in response to an input of the graphics data, outputs legacy mesh shader output parameters including vertices and primitives, and additional data with a meshlet bounding-box, or axis-aligned bounding box AABB) structure, as shown FIG. 1. The AABB is the smallest possible rectangle or polygon aligned with the axes of that element's user coordinate system that entirely encloses it and its descendants.

At step 120, the AABB is sent to the tiler as an input, and the tiler then generates a visibility stream according to the AABB. In some examples, the tiler comprises a visibility test configured to determine if the AABB is visible in the current view frustum. The functional block of the visibility test can be implemented by hardware and/or software.

The visibility stream is a bit stream or an index buffer with the smallest possible storage size. Each entity of the visibility stream indicates that the AABB is fully visible, partially visible, or invisible in the view frustum. The value of each entity in the visibility stream is identified as any degree of visibility of the corresponding AABB in the view frustum, or a direct or an indirect address to access any data of the fully or partially visible AABB.

In some embodiments, the visibility stream is a compressed data, and the decompression of it is involved in the fragment pass.

At step 130, the visibility stream is sent back to the tiler as a further input along with the legacy mesh shader output parameters for coming rasterization in the fragment pass.

According to some embodiments, only the vertices and primitives bounded by the AABB which is indicated visible in the visibility stream are rendered in the fragment pass. The invisible AABB, which has no corresponding entity or is indicated as invisible found with its corresponding entity of the visibility stream, is regarded culled and not be rendered with its bounded vertices and primitives.

Yet another aspect of the invention provides a non-transitory tangible computer-readable medium storing instructions which, when executed by one or more processors, cause a system to perform the above disclosed method of processing graphics data. The computer executable instructions or program codes enable a computer or a similar computing system to complete various operations in the above disclosed method of foveated rendering of omnidirectional media content. The storage medium/memory may include, but is not limited to, high-speed random access medium/memory such as DRAM, SRAM, DDR RAM or other random access solid state memory devices, and non-volatile memory such as one or more magnetic disk storage devices, optical disk storage devices, flash memory devices, other non-volatile solid state storage devices, or any other type of non-transitory computer readable recoding medium commonly known in the art.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method for processing graphics data with a graphics rendering pipeline comprising a mesh shader and a tiler, the method comprising:
outputting, by the mesh shader in response to an input of the graphics data, legacy mesh shader output parameters including vertices and primitives, and additional data with a meshlet bounding-box, or axis-aligned bounding box (AABB) structure;
sending the AABB to the tiler as an input, and generating, by the tiler, a visibility stream according to the AABB, wherein each entity of the visibility stream indicates that the AABB is fully visible, partially visible, or invisible in the view frustum; and
sending the visibility stream back to the tiler as a further input along with the legacy mesh shader output parameters for coming rasterization in a fragment pass.

2. The method of claim 1, wherein the tiler comprises a visibility test configured to determine if the AABB is visible in the current view frustum.

3. The method of claim 2, wherein the visibility test is implemented by hardware and/or software.

4. The method of claim 1, wherein the invisible AABB, which has no corresponding entity or is indicated as invisible found with its corresponding entity of the visibility stream, is regarded culled and not be rendered with its bounded vertices and primitives.

5. The method of claim 1, wherein only the vertices and primitives bounded by the AABB which is indicated visible in the visibility stream are rendered in the fragment pass.

6. The method of claim 1, wherein the AABB is the smallest possible rectangle or polygon aligned with the axes of that element's user coordinate system that entirely encloses it and its descendants.

7. The method of claim 1, wherein the visibility stream is a bit stream or an index buffer with the smallest possible storage size, and wherein the value of each entity in the visibility stream is identified as any degree of visibility of the corresponding AABB in the view frustum, or a direct or an indirect address to access any data of the fully or partially visible AABB.

8. The method of claim 1, wherein the visibility stream is a compressed data, and the decompression of it is involved in the fragment pass.

9. The method of claim 1, wherein the visibility stream may be operated as an additional input in the fragment pass, or be used as a factor for judging the eligibility of the mesh shader being executed in the fragment pass and rendered in the later fragment shader stage, or being skipped in the fragment pass.

10. A system for processing graphics data, comprising:
a compiler; and
a graphics rendering pipeline comprising a mesh shader and a tiler, coupled with the compiler, and configured such that:
in response to an input of the graphics data, the mesh shader outputs legacy mesh shader output parameters including vertices and primitives, and additional data with a meshlet bounding-box, or axis-aligned bounding box (AABB) structure;
in a first pass, the compiler instructs the AABB being sent to the tiler as an input, and the tiler then generates a visibility stream accordingly, wherein each entity of the visibility stream indicates that the AABB is fully visible, partially visible, or invisible in the view frustum; and
in a consecutively second pass, the compiler instructs the visibility stream being sent back to the tiler as a further input along with the legacy mesh shader output parameters for coming rasterization in a fragment pass.

11. The system of claim 10, wherein the tiler comprises a visibility test configured to determine if the AABB is visible in the current view frustum.

12. The system of claim 11, wherein the visibility test is implemented by hardware and/or software.

13. The system of claim 10, wherein the invisible AABB, which has no corresponding entity or is indicated as invisible found with its corresponding entity of the visibility stream, is regarded culled and not be rendered with its bounded vertices and primitives.

14. The system of claim 10, wherein only the vertices and primitives bounded by the AABB which is indicated visible in the visibility stream are rendered in the fragment pass.

15. The system of claim 10, wherein the AABB is the smallest possible rectangle or polygon aligned with the axes of that element's user coordinate system that entirely encloses it and its descendants.

16. The system of claim 10, wherein the visibility stream is a bit stream or an index buffer with the smallest possible storage size, and wherein the value of each entity in the visibility stream is identified as any degree of visibility of the corresponding AABB in the view frustum, or a direct or an indirect address to access any data of the fully or partially visible AABB.

17. The system of claim 10, wherein the visibility stream is a compressed data, and the decompression of it is involved in the fragment pass.

18. The system of claim 10, wherein the visibility stream may be operated as an additional input in the fragment pass, or be used as a factor for judging the eligibility of the mesh shader being executed in the fragment pass and rendered in the later fragment shader stage, or being skipped in the fragment pass.

19. A non-transitory computer readable storage medium storing instructions, which when executed by one or more processors, cause a method of processing graphics data with a graphics rendering pipeline comprising a mesh shader and a tiler to be performed, the method comprising:
outputting, by the mesh shader in response to an input of the graphics data, legacy mesh shader output parameters including vertices and primitives, and additional data with a meshlet bounding-box, or axis-aligned bounding box (AABB) structure;
sending the AABB to the tiler as an input, and generating, by the tiler, a visibility stream according to the AABB, wherein each entity of the visibility stream indicates that the AABB is fully visible, partially visible, or invisible in the view frustum; and
sending the visibility stream back to the tiler as a further input along with the legacy mesh shader output parameters for coming rasterization in a fragment pass.

20. The non-transitory computer readable storage medium of claim 19, wherein only the vertices and primitives bounded by the AABB which is indicated visible in the visibility stream are rendered in the fragment pass.
